(19) United States
(12) Patent Application Publication
(10) Pub. No.: US 2007/0243515 A1
(43) Pub. Date: Oct. 18, 2007

(54) System for facilitating the production of an audio output track

(76) Inventor: Geoffrey C. Hufford, Cedarburg, WI (US)

Correspondence Address: ARTHUR FREILICH;FREILICH, HORNBAKER & ROSEN, 20555 DEVONSHIRE ST. #372, CHATSWORTH, CA, 91311, US

(21) Appl. No.: 11/787,080

(22) Filed: Apr. 12, 2007

Related U.S. Application Data
(60) Provisional application No. 60/792,227, filed on Apr. 14, 2006.

(51) Int. Cl. G09B 5/04

(52) U.S. Cl. 434/319

(57) ABSTRACT

An enhanced audio mixing, or editing, system characterized by a “mood” controller operable by an editor/user to control the audio mixing of multiple layers of a sound source. A mood controller in accordance with the invention stores one or more moods where each mood comprises a data set which specifies levels applicable to the multiple layers f a specified sound source. The mood controller is configured to allow an editor/user to produce a mix, or audio output track, by selecting a stored mood, or a sequence of stored moods, for application to, i.e., modulation of, a selected multilayer sound source.

### RELATED APPLICATIONS

This application claims priority based on U.S. provisional application 60/792,227 filed on 14 Apr. 2006.

### FIELD OF THE INVENTION

This invention relates generally to audio mixing systems and more particularly to such a system for facilitating the production by a human sound editor of an audio output track suitable for accompanying a film/video track.

### BACKGROUND OF THE INVENTION

In order to produce a track of music and/or background sound effects for use in film and video production, it is advantageous to initially discretely record each sound element so that a human sound editor can later selectively adjust the ratio between respective sound elements. The process of adjusting and combining the sound elements to produce an audio output track is commonly referred to as audio mixing.

The process of audio mixing has typically involved the editor making small iterative amplitude, or “level”, adjustments over time in an effort to produce an audio output track which supports the content of a film/video track and assures that a listener will be able to discern the various sound elements. For instance, if a video production has a narrator, the accompanying music may make it difficult for the listener to understand the narration if the musical texture is not thinned or lowered in volume. Reducing the amplitude level of musical elements relative to the level of narration will help ensure that a listener can understand the narrator while simultaneously hearing the underlying music. Ideally, not all musical elements will be reduced by the same proportion, and in some cases it may be desirable to have some elements remain constant or increase. Generally speaking, musical elements that are busy or contain frequencies in the same range as the narrators voice are the most likely to make it difficult to understand the narration, and therefore are the best candidates to be lowered in volume.

Additionally, the character of a musical piece can be varied significantly by adjusting the ratio between levels of its sound elements. For instance, if percussive elements are reduced or removed, then the resulting audible music will generally be perceived as sounding “smoother” whereas an increase in lower pitched sounds will generally be perceived as making the music “heavier.” Thus, the character of the music can be varied by adjusting the ratio of the levels of percussive, low pitched, and other elements at specific points in time.

Audio mixing is typically performed by a human editor using either a specialized mixing console or an appropriately programmed computer. The editor typically will repeatedly listen to the various sound elements while varying the respective levels to achieve a pleasing mix of levels and level changes at specific points in time. The process is often one of trial-and-error as the editor explores the multitude of possible combinations. Existing mixing systems sometimes provide methods for automating the mixing to afford the editor the opportunity to program each level change one at a time, with the computer functioning to memorize and replay the level changes. While such known mixing systems can assist in remembering and replaying the level changes, each level change must be individually entered by the editor. This makes the editing process cumbersome inasmuch as it is often desirable to have several levels changing simultaneously at different rates and directions to progress from one mix to another. A more advanced mixing system might have a capability of “sub-mixing” which allows several faders to be grouped together and commonly controlled. The user of such a system can individually set a desired level for each sound element, and then assign the levels to a common controller to be proportionally raised or lowered.

### SUMMARY OF THE INVENTION

The present invention is directed to an enhanced audio mixing, or editing, system characterized by a “mood” controller operable by an editor/user to control the audio mixing of multiple layers of a sound source. A mood controller in accordance with the invention stores one or more moods where each mood comprises a data set which specifies levels applicable to the multiple layers of a specified sound source. The mood controller is configured to allow an editor/user to produce a mix, or audio output track, by selecting a stored mood, or a sequence of stored moods, for application to, i.e., modulation of, a selected multilayer sound source.

As used herein, a multilayer sound source refers to a collection of discrete sound layers intended for concurrent playback to form an integrated musical piece. Each layer typically represents a discrete recording of one or more musical instruments of common tonal character represented as one or more data files. The data files can be presented in various known formats (e.g., digital audio, MIDI, etc.) and processed for playback to produce an integrated musical piece consisting of simultaneously performing instruments or synthesized sounds.

A preferred mood controller in accordance with the present invention comprises a unitary device including a mood storage for storing one or more preset moods, where each mood comprises a data set associated with an identified sound source. The mood controller is configured to enable an editor/user to selectively modify the levels of each stored mood.

Further, a preferred system in accordance with the invention is operable to enable the editor/user to specify and store a sequence of one or more moods across the duration of a sound source timeline selected by the editor/user. The preferred system allows one or more moods to be active during each slice of the timeline duration and allows the editor/user to adjust the ratio between successive moods to achieve smooth transitions

Embodiments of the invention are particularly suited for producing an audio output track to accompany a video track by enabling the user to dynamically match the mix and character of the sound to the changing moods of the video.

Although embodiments of the present invention can take many different forms, one preferred embodiment is commercially marketed as the Sonicfire Pro 4 software by SmartSound Software, Inc., for the use with computers running Windows or Macintosh OSX. Supplemental information relevant to the Sonicfire Pro 4 product is available at www.smartsound.com, a portion of which is included in the attached Appendix which also contains portions of the Sonicfire Pro 4 user manual, which is incorporated herein by reference.

### BRIEF DESCRIPTION OF THE FIGURES

FIG. 1 is a high level block diagram of a system in accordance with the invention for enabling an editor/user to selectively apply stored “moods” to a multilayer sound source;

FIG. 2 is a table representing multiple layers of an exemplary multilayer sound source;

FIG. 3 is a table representing a collection of exemplary moods to be applied to a multilayer sound source in accordance with the present invention;

FIG. 4 is a high level block diagram similar to FIG. 1 but representing the application of a sequence of moods to a multilayer sound source;

FIG. 5 is a chart representing a sequence of moods (M1, M2 . . . Mx) applied to a multilayer sound source over an interval of time slices (T1, T2 . . . Tx);

FIG. 6 is a plot depicting a transition from a current mood (Mc) to a next mood (Mn);

FIG. 7 is a flow chart depicting the functional operation of a system in accordance with the invention;

FIG. 8 is a flow chart depicting the internal operation of a system in accordance with the invention; and

FIG. 9 comprises a display of a preferred graphical user interface in accordance with the present invention.

### DETAILED DESCRIPTION

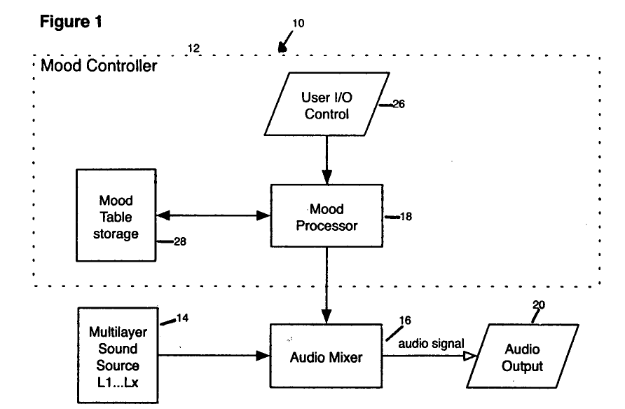

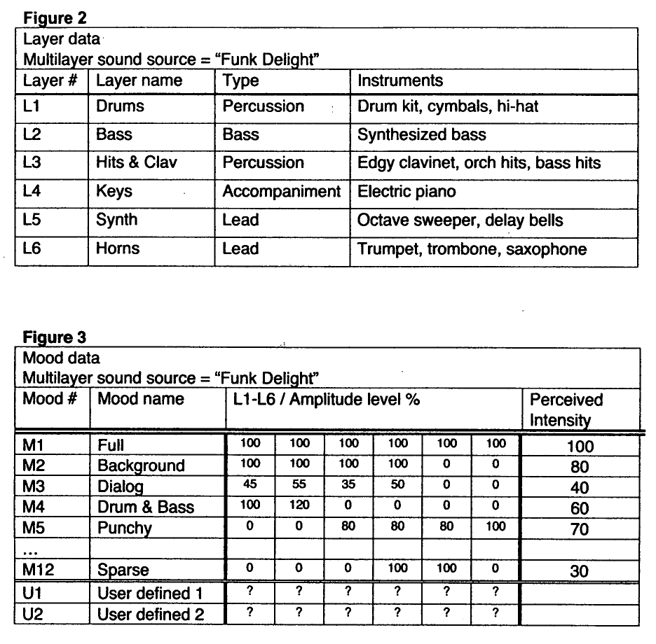

Attention is initially directed to FIG. 1 which depicts a system 10 in accordance with the present invention for assisting an editor/user to produce an audio output track suitable for accompanying a video track. The system 10 is comprised of a mood controller 12 which operates in conjunction with a multilayer sound source 14 which provides multiple discrete sound layers L1, L2 . . . Lx. An exemplary multilayer source 14 (denominated “Funk Delight”) is represented in the table of FIG. 2 as including layers L1 through L6. Each layer includes one or more musical instruments having common tonal characteristics. For example, layer L1 (denominated “Drums”) is comprised of multiple percussive instruments and layer L6 (denominated “Horns”) is comprised of multiple wind instruments. FIG. 1 shows that the multiple layers L1-L6 provided by source 14 are applied to audio mixer 16 where they are modulated by mood controller processor 18 to produce an audio output track 20.

The mood controller 12 is basically comprised of the mood processor 18, e.g., a programmed microprocessor, having associated memory and storage, and a user input/output (I/O) control device 26. Although not shown, it should be understood that the device 26 includes conventional user input means such as a pointing device, e.g., mouse, keyboard, rotary/slide switches, etc. The device 26 also preferably includes a conventional output device including a display monitor and speakers. Thus, the mood controller 12 can be implemented via readily available desktop or laptop computer hardware.

In accordance with the invention, the mood controller 12 stores multiple preset, or preassembled, sets of mood data in mood table storage 28. The mood data sets are individually selectable by an editor/user, via the control device 26, to modulate a related sound source. FIG. 3 comprises a table representing exemplary multiple preset mood data sets M1-M12 and one or more user defined mood data sets U1-U2. Each mood data set comprises a data structure specifying a certain level, or amplitude, for each of the multiple layers L1-Lₓ of a sound source. For example only, a typical set of moods might include: (M1) Full, (M2) Background, (M3) Dialog, (M4) Drums and Bass, and (M5) Punchy. Each mood data set specifies multiple amplitude levels respectively applicable to the layers L1-L6, represented in FIG. 2. The levels of each mood are preferably preset and stored for ready access by a user via the I/O control device 26. However, in accordance with a preferred embodiment of the invention, the user is able to adjust the preset levels via the I/O device 26 and also to create and store user moods, e.g., U1, U2. In addition to listing the amplitude levels for each mood, the table of FIG. 3 also shows an optional column which lists the “perceived intensity” of each mood. Such intensity information is potentially useful to the editor/user to facilitate his selection of a mood appropriate to a related video track.

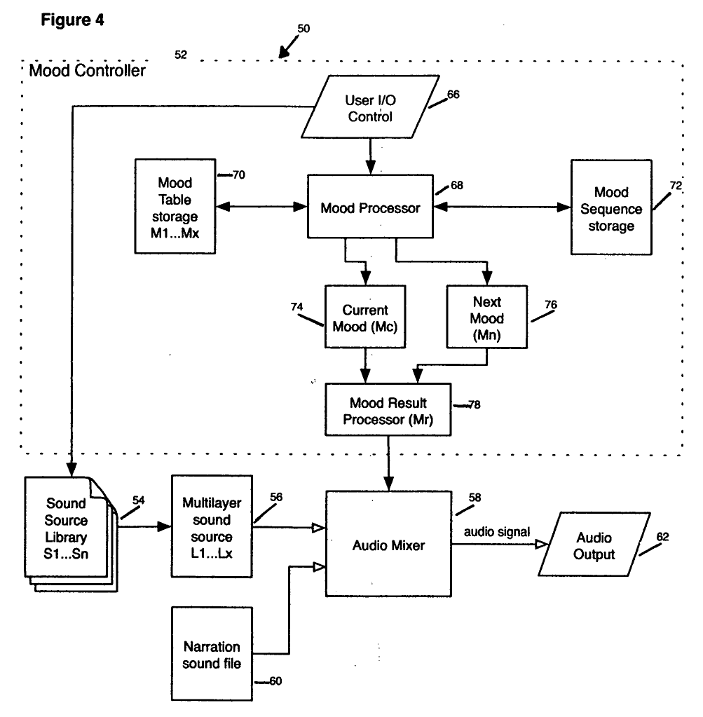

Attention is now directed to FIG. 4 which depicts a more detailed (as compared with FIG. 1) embodiment 50 of the invention. FIG. 4 includes a mood controller 52 operable by an editor/user to select a multiplayer sound source S1 . . . Sn from a source library 54. The selected source 56 provides multiple sound layers L1 . . . Lx to an audio mixer 58. One or more additional audio sources, e.g., a narration sound file 60, can also be coupled to the input of audio mixer 58. The multiple sound layers L1 . . . Lx are modulated in mixer 58, by control information output by the mood controller 52, to produce an audio output track 62.

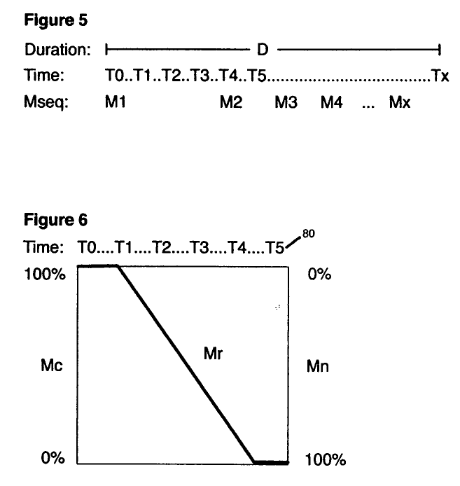

The mood controller 52 of FIG. 4 includes a user I/O control device 66, a mood processor 68, and a mood table storage 70, all analogous to the corresponding elements depicted in FIG. 1. The mood controller 52 of FIG. 4 additionally includes a mood sequence storage 72 which specifies a sequence of moods to be applied to audio mixer 58 consistent with a predetermined timeline. More particularly, FIG. 5 represents a timeline of duration D which corresponds to the time duration of the layers L1 . . . Lx of the selected sound source 56. FIG. 5 also shows the timeline D as being comprised of successive time slices respectively identified as T0, T1, . . . Tx and identifies different moods active during each time slice. Thus, in the exemplary showing of FIG. 5, mood M1 is active during time slices T0-T3, mood M2 is active during time slices T4, T5, etc.

In operation, the mood processor 68 accesses mood sequence information from storage 72 and responds thereto to access mood data from storage 70. It is parenthetically pointed out that the mood sequence storage 72 and mood table storage 70 are depicted separately in FIG. 4 only to facilitate an understanding of their functionality and it should be recognized that they would likely be implemented in a common storage device.

As a consequence of accessing the mood sequence information from the storage 72, the processor 68 will know the identity of the current mood (Mc) and also the next mood (Mn). In order to smoothly transition between successive moods, it is preferable to gradually decrease influence of Mc while gradually increasing the influence of Mn. This smooth transition is graphically represented in FIG. 6 which shows at time slice T0 that the resultant mood (Mr) is 100% attributable to the current mood (Mc) and 0% attributable to the next mood (Mn). This gradually changes so that at time slice T4, the resultant mood (Mr) is 100% attributable to Mn and 0% attributable to Mc. The development of Mr as a function of Mc and Mn is represented in FIG. 4 by current mood register 74, next mood register 76, and mood result processor 78. That is, Mc and Mn mood data is loaded into registers 74 and 76 by processor 68. The mood result processor 78 then develops Mr and a rate specified by the editor/user via I/O control 66.

To assure smooth transitions between successive moods Mc and Mn, it is preferable to provide a user control to set a desired transition rate or slope. The user control preferably comprises a single real or virtual knob or slider. Consider, for example, FIG. 6, which depicts an exemplary transitioning from mood Mc to mood Mn along a timeline 80. The processor 78 (FIG. 4) can calculate at each time slice Tn in the timeline the appropriate contribution from moods Mc and Mn. Consider, for example, the following exemplary mix calculation:

### V—Mood Controller value in range of 0 . . . 100%

### Mc—Mood with x sound layer levels

### Mn—Mood with x sound layer levels

### Mr—Calculated result for each sound layer level

### Mrx=Mcx+((Mnx−Mcx)*V),—Linear interpolation formula

### Example: [5 layers, in range of 0 . . . 100]

V=0.5

Mc={0, 25, 50, 75, 100}

Mn={50, 50, 50, 0, 0}

Mr={25, 37.5, 50, 37.5, 50}

The example above uses a linear interpolation formula to calculate the value of Mrx. Other formulae for interpolation between the Mcx and Mnx values may be substituted, including exponential scaling, favoring one mood over the other, or weighting the calculation based on the layer number (x).

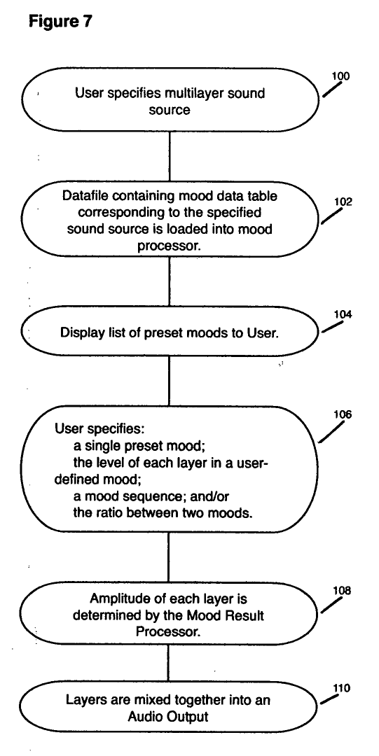

Attention is now directed to FIG. 7 which depicts a high level flow chart showing a sequence of steps involved in the use of the system of FIG. 4 by an editor/user. Step 100 represents the user specifying a multiplayer sound source from the library 54. Step 102 represents the mood processor 68 accessing mood data applicable to the selected sound source from storage 70. Step 104 represents the processor 68 displaying a list of available preset moods applicable to the selected sound source to the user via I/O device 66. Step 106 represents the selection by the user of one of the displayed moods. Step 106 represents a user action taken via the I/O control device 26. That is, the user can selectively (a) specify one of the displayed preset moods, (b) create a user defined mood, e.g., UI, (c) specify a sequence of moods, and/or (d) specify a ratio between moods. Step 108 represents the processor, e.g., mood result processor 78, determining the amplitude level of each layer for application to the audio mixer 58. Step 110 represents the action of the mixer 58 modulating the layers of the selected sound source with the modulating levels provided by processor 78 to produce the audio output 62.

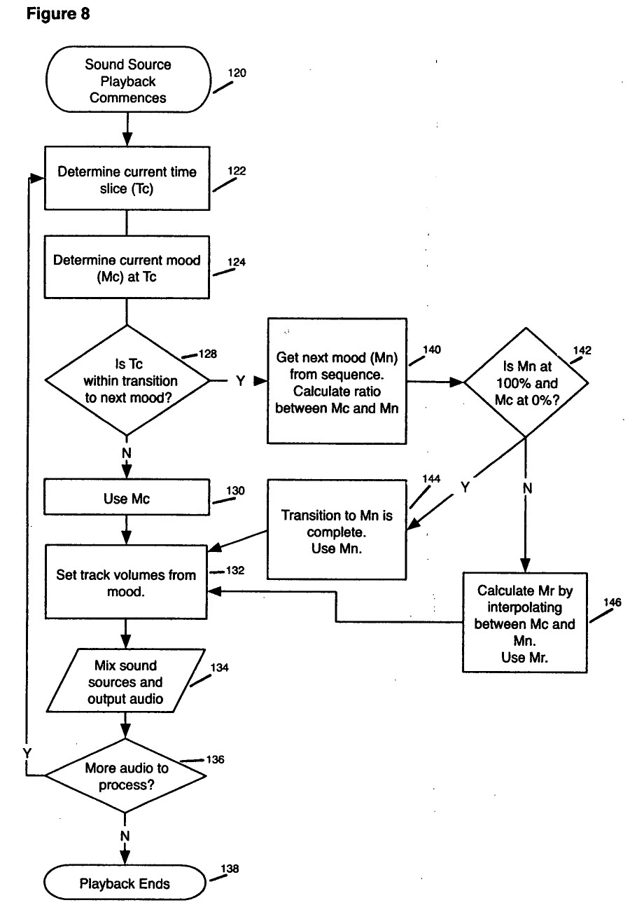

Attention is now directed to FIG. 8 which comprises a flow chart depicting the internal processing steps executed by a system in accordance with the invention as exemplified by FIG. 4. Step 120 initiates playback of the selected sound source 56. Step 122 determines the current time slice Tc. Step 124 determines the current mood Mc at time slice Tc. Step 128 determines whether the current time slice Tc is a transition time slice, i.e., whether it falls within the interval depicted in FIG. 6 where Mr is transitioning from Mc to Mn. If the decision block of step 128 answers NO, then operation proceeds to step 130 which involves using the current mood Mc to set the amplitudes for the multiple sound source layers in step 132. Step 134 represents the modulation of the layers in the audio mixer 58 by the active mood. Step 136 determines whether additional audio processing is required. If NO, then playback ends as is represented by step 138. If YES, then operation loops back to step 122 to process the next time slice.

With continuing reference to FIG. 8, if step 128 answered YES, meaning that a mood transition is to occur during the current time slice Tc, then operation proceeds to step 140. Step 140 retrieves the next mood Mn from storage 72 and calculates an appropriate ratio relating Mc and Mn. Operation then proceeds to step 142 which asks whether or not the transition has been completed, i.e., has Mn increased to 100% and Mc decreased to 0%. If YES, then operation proceeds to step 144 which causes aforementioned step 132 to use the next mood Mn. On the other hand, if step 142 answered NO, then operation proceeds to step 146 which calculates a result mood set Mr for the current time slice. In this event, step 132 would use the current value of Mr to set the amplitudes for modulating the multiple sound layers in audio mixer 58 in step 132.

As previously noted, a preferred embodiment of the invention is being marketed by SmartSound Software, Inc. as the Sonicfire Pro 4. Detailed information regarding the Sonicfire Pro 4 product is available at www.smartsound.com. Briefly, the product is characterized by the following features:

### Mood Mapping™

Quickly select from a list of preset moods for each track, including “dialog”, “drums & bass”, “acoustic”, “atmospheric”, “heavy” and more.
Set the Mood Map track to match the changes in your video track and then simply select the ideal mood for each section. The mix and feel of the music will dynamically adapt to each mood along the timeline.
Easily fine-tune individual instrumental layers for each mood. Duck the horn section down or push up the strings to add suspense with a simple slider control.

### Multitrack Interface

Import voice-over tracks or create layers of music and sound effects in a Multitrack interface for complete control over the audio elements of your project.

### Multi-Layer Music

Multi-Layer source music delivers each instrument layer separately for total customization of the music

### Preview With Timeline

Use the “Preview with Timeline” feature to play your video when sampling music tracks to quickly find the best fit

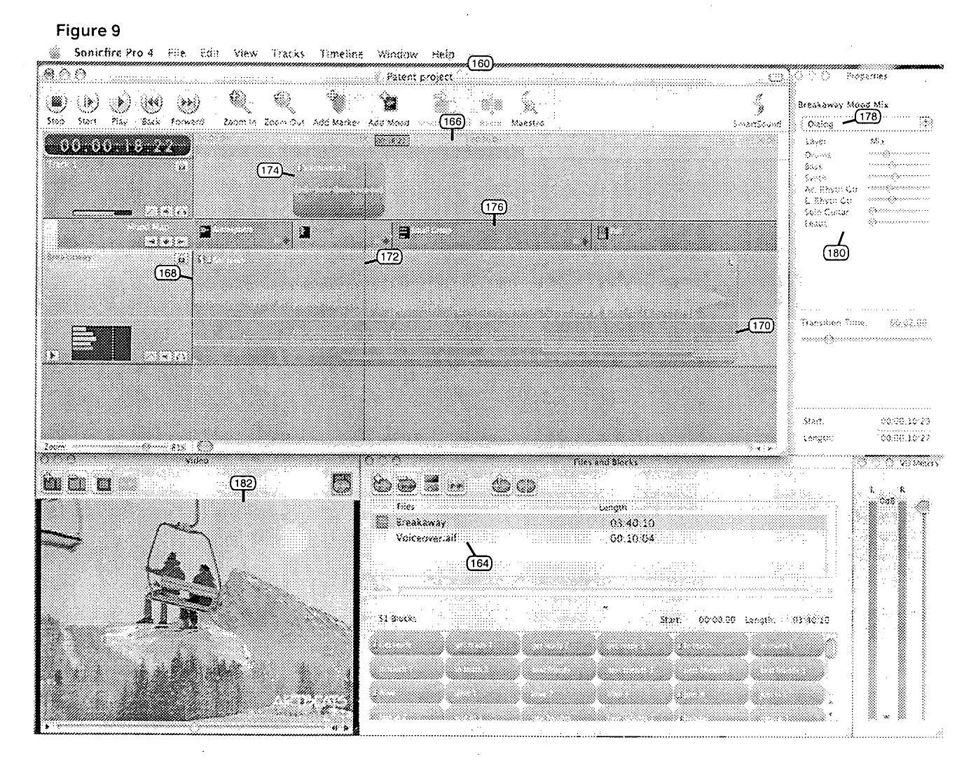

Attention is now directed to FIG. 9 which illustrates an exemplary display format 160 characteristic of the aforementioned Sonicfire Pro 4 product for assisting a user to easily operate the I/O control 26, 66 for producing a desired audio output track 20, 62. Several areas of the display 160 should be particularly noted:

Area 164 shows that two selected files respectively identified as “Breakaway” and “Voiceover.aif” are open and also shows the total time length of each of the files.

Area 166 depicts a timeline 168 of the selected “Breakaway” multilayer sound source track and shows the multiple layers 170 of the track extending along the timeline. Note time marker 172 which translates along the timeline 168 as the track is played to indicate current real time position.

Area 174 depicts the positioning of the user selected “Voice Over-Promo” track relative to the timeline 168 of the “Breakaway” track.

Area 176 depicts selected moods, i.e., Atmosphere, Dialog, Small Group, Full, which are sequentially placed along the timeline 168. Note that mood Dialog is highlighted in FIG. 9 to show that it is the currently active mood for the illustrated position of the time marker 172.

Area 178 includes a drop down menu which enables a user to select a mood for adjustment.

Area 180 includes multiple slide switch representations which enables a user to adjust the levels of the selected mood for each of the multiple layers of the selected “Breakaway” sound source track.

Area 182 provides for the dynamic display of a video track to assist the user in developing the accompanying audio output track.

In the use of the system described herein, the user can initially size the timeline 168 depicted in FIG. 9 to a desired track duration. The user then will have immediate access to control the desired instrument mix, i.e., layers, for the track. The mood drop down menu (area 178) gives the user access to a complete list of different preset instruments mixes. For instance, the user can select Atmospheric. This is the same music track but with only a selected group of instruments playing. Alternatively, the user can select a Drum and Bass mix. The controls available to the user enable him to alter a source track to his liking by, for example, deleting an instrument that could be getting in the way or just not sounding right in the source track. If the user selects the full instrument mix and clicks on the Mood-Map track, he will have access to all of the instrument layers in the properties window 180. If he didn't like the electric guitar in that variation, for example, he could just lower the two lead guitars and play that variation again. Thus the system enables the user to map the moods on the timeline 168 to dynamically fit the needs of the video track represented in display area 182.

By looking at the video in display area 182, the user can get an idea of what he might want to do with the mood-mapping feature. That is, he will likely acquire ideas on where he might want to change the music to meet the mood of the video. So, up on the mood timeline 176, he can create some transition points by clicking an “add mood” button. This action causes the mood map to appear providing new mood blocks for selection by the user. The user is then able to click on a first mood to select it for the beginning of the video. He may want to start off with something less full so he might choose a Sparse mood. Later, we may have some dialog so he can then select a Dialog mood. The nice thing about the Dialog mood is that its preset removes the instruments that would get in the way of voice narration and it lowers the overall instrument volume levels applied to the sound source layers. For the next mood, he may choose a Small Group mix and then for the last mapped mood, he can elect to leave that as a Full mix. The system then enables the user to again watch the video from beginning to end with the mood mapping activated for the current sound source.

The digital files that comprise a multilayer sound source and the associated preset mood data files are preferably collected together onto a computer disk, or other portable media, for distribution to users of the system. Such preset mood data files are typically created by a skilled person, i.e., music mixer, after repeatedly listening to the sound source while varying the characteristics of the mood can be indexed, including but not limited to, density, activity, pitch, or rhythmic complexity.

From the forgoing, it should now be understood that a sound editing system has been described for enabling a user to easily produce and modify an audio output track by applying a selected sequence of preset moods to a source track. The invention can be embodied in various alternatives to the preferred embodiment discussed herein and in the attached Sonicfire Pro 4 user manual.

1. A system for facilitating the production of an audio output track comprising:
at least one source of multiple discrete sound layers configured for concurrent playback to produce a musical piece;
a data storage storing at least two different sets of mood data where each such set defines multiple amplitude levels respectively applicable to said multiple discrete sound layers;
a control device for enabling a user to select a set of mood data from said data storage; and
an audio mixer for modulating said multiple discrete sound layers with respective amplitude levels derived from a selected set of mood data to produce said audio output track.

2. The system of claim 1 wherein said multiple discrete sound layers define a duration comprised of sequential time slices;
a mood sequence storage defining at least one mood data set applicable to each of said time slices; and
a mood processor responsive to said mood sequence storage for applying during each time slice at least one mood data set to said audio mixer for modulating said multiple discrete sound layers to produce said audio output track.

3. The system of claim 2 wherein two or more mood data sets are concurrently applicable to at least one of said time slices; and wherein
said control device enables a user to adjust the ratio between said mood data sets concurrently applicable to a time slice.

4. The system of claim 2 wherein said control device further enables a user to select and store a sequence of mood data sets in said mood sequence storage.

5. The system of claim 1 further including a sound source library containing a plurality of sources each including multiple discrete sound layers; and
a control device for enabling a user to select said at least one source from said sound source library.

6. The system of claim 1 wherein said multiple discrete sound layers and said mood data sets are represented by respective digital data files.

7. The system of claim 5 wherein said respective digital data files are stored together for distribution on a portable storage media.

8. A method for facilitating the production of an audio output track comprising:
providing at least one sound source including multiple discrete sound layers configured for concurrent playback to produce a musical piece;
storing at least two different sets of mood data where each set defines multiple amplitude levels respectively applicable to said multiple discrete sound layers of said sound source;
selecting at least one of said sets of mood data; and
modulating said multiple discrete sound layers with respective amplitude levels of said selected mood data set to produce an audio output track.

9. The method of claim 8 including a step of providing multiple sound sources each comprised of multiple discrete sound layers; and including a further step of
selecting one of one of multiple sound sources.

10. The method of claim 8 including a further step of displaying stored mood data sets applicable to said selected sound source.

11. The method of claim 8 including a further step of specifying a sequence of stored moods applicable to said sound source.

12. A system operable by a user for producing an audio output track to accompany a video source track, said system comprising:
a library storing a plurality of sound sources where each sound source includes multiple discrete sound layers;
a mood storage storing a plurality of mood data sets where each data set defines multiple amplitude levels respectively applicable to the multiple layers of a related sound source;
an input device for enabling a user to select one of said sound sources and at least one of said mood data sets relating to said selected sound source; and
an audio mixer responsive to said selected mood data set for modulating the respective sound layers of said selected sound source.

13. The system of claim 12 wherein said plurality of sound sources and said mood data sets comprise digital data files; and wherein
said digital data files are stored on a common portable storage media.

14. The system of claim 12 wherein each sound source defines a duration comprised of sequential time slices; and wherein
Said input device is operable by a user to specify a sequence of moods including at least one mood during each time slice.

15. The system of claim 14 wherein said input device is operable by a user to specify a selected ratio between moods in said sequence.

16. The system of claim 12 further including an output device for displaying the moods in said mood storage applicable to a selected sound source.
